(19) United States
(12) Patent Application Publication
(10) Pub. No.: US 2014/0359339 A1
(43) Pub. Date: Dec. 4, 2014

(54) APPARATUS AND METHOD FOR DETECTING POWER FAILURE

(71) Applicants: HON HAI PRECISION INDUSTRY CO., LTD., New Taipei (TW); HONG FU JIN PRECISION INDUSTRY (Shenzhen) CO., LTD., Shenzhen (CN)

(72) Inventor: JIN-YAN SUN, Shenzhen (CN)

(73) Assignees: HON HAI PRECISION INDUSTRY CO., LTD., New Taipei (TW); HONG FU JIN PRECISION INDUSTRY (Shenzhen) CO., LTD., Shenzhen (CN)

(21) Appl. No.: 14/199,970

(22) Filed: Mar. 6, 2014

(30) Foreign Application Priority Data
May 29, 2013 (CN) 2013102060214

(51) Int. Cl. G06F 1/30

(52) U.S. Cl. CPC G06F 1/30
USPC 713/340

(57) ABSTRACT

A power failure detection apparatus includes a comparison circuit and a logic device. The comparison circuit may receive a power signal from a power supply unit and compare a voltage of the power signal with a predefined voltage value. When the voltage of the power signal is not equal to the predefined voltage value, the comparison circuit sends a power failure signal to the logic device. The logic device generates power failure information based on the power failure signal. A power failure detection method is also provided.

### REFERENCE TO RELATED APPLICATIONS

This application claims all benefits accruing under 35 U.S.C. §119 from China Patent Application No. 201310206021.4, filed on Mar. 29, 2013 in the State Intellectual Property Office of China. The contents of the China Application are hereby incorporated by reference.

### BACKGROUND

1. Technical Field

The disclosure generally relates to power failure detection, and particularly relates to apparatuses and methods for detecting a power failure of a power supply unit (PSU).

2. Description of Related Art

A typical server computer usually has multiple power supply units (PSUs). When one of the PSUs fails, the other PSUs can continue powering the server without power interruption. A related person, (e.g., a system technician) needs to repair the failed PSU or replace it with a new one. However, the known power failure detection system cannot detect the power failure of the PSU and inform the related person of the power failure rapidly enough.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of an embodiment of a power failure detection apparatus.

FIG. 2 is a flowchart of an embodiment of a power failure detection method.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

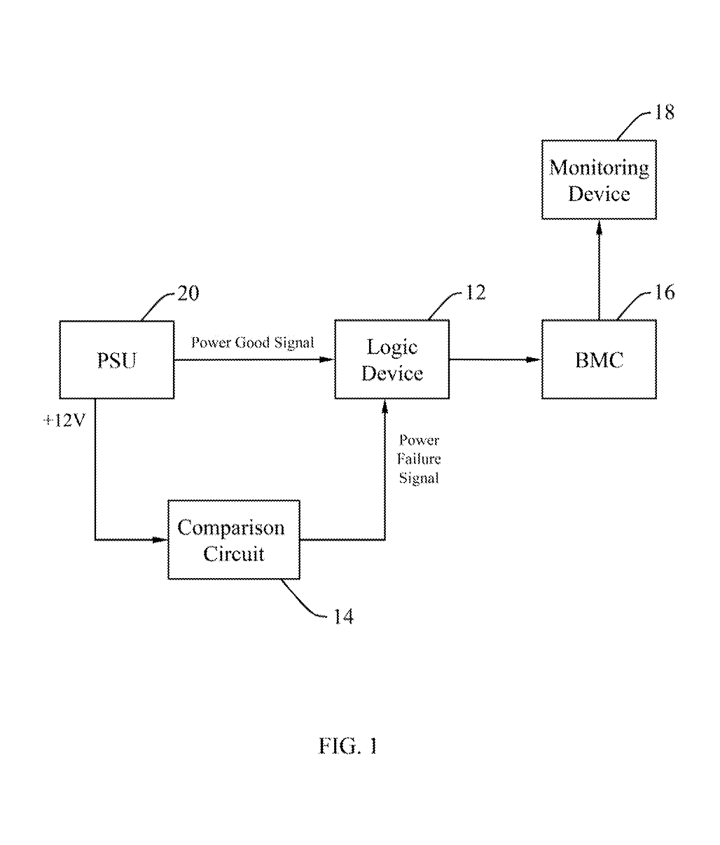

FIG. 1 is a block diagram of an embodiment of a power failure detection apparatus. The power failure detection apparatus may be installed in an electronic device which can be, but is not limited to, a notebook computer, a tablet computer, a gaming device, a DVD player, a radio, a television, a personal digital assistant (PDA), a smart phone, or any other type of portable or non-portable electronic device.

In the illustrated embodiment, the power failure detection device includes a logic device 12, a comparison device 14, a baseboard management controller (BMC) 16, and a monitoring device 18. The logic device 12 is connected to the comparison circuit 14. The BMC 16 is connected to the logic device 12. The monitoring device 18 is in communication with the BMC 16 via an Internet protocol (IP) network.

The comparison circuit 14 may receive a power signal from a PSU 20 and compare a voltage of the power signal with a predefined voltage value, e.g., +12V. When the voltage of the power signal is not equal to the predefined voltage value, the comparison circuit 14 may send a power failure signal to the logic device 12. In one embodiment, the comparison circuit 14 is an operational amplifier.

When the logic device 12 receives the power failure signal from the comparison circuit 14, the logic device 12 may generate power failure information based on the power failure signal from the comparison circuit 14 and send the failure information to the BMC 16. In some embodiments, the logic device 12 may be a complex programmable logic device (CPLD) or a field programmable gate array (FPGA).

The logic device 12 may collect state information of the PSU 20 and add the state information of the PSU 20 into the power failure information. The logic device 12 may detect whether the PSU 20 generates a power good signal. When the PSU 20 does not generate the power good signal, the logic device 12 may determine that the PSU 20 is powering on and in a powering-on state. When the PSU 20 generates the power good signal, the logic device 12 may determine that the PSU 20 has been powered on and is in a powered-on state.

The BMC 16 is a specialized microcontroller embedded on a motherboard of a computing device. The BMC 16 manages an interface between system management software and platform hardware. When the BCM 16 receives the power failure information from the logic device 12, the BMC 16 may send the power failure information to the monitoring device 18 via the IP network.

The monitoring device 18 may generate an alarm to inform of the power failure information in response to receiving the power failure information from the BMC 16. In one embodiment, the monitoring device 18 includes a display configured to display the power failure information. When a related person (e.g., a system technician) is informed of the power failure information, the person can take actions to cut off the power, repair the PSU 20 or replace the PSU 20 with a new one.

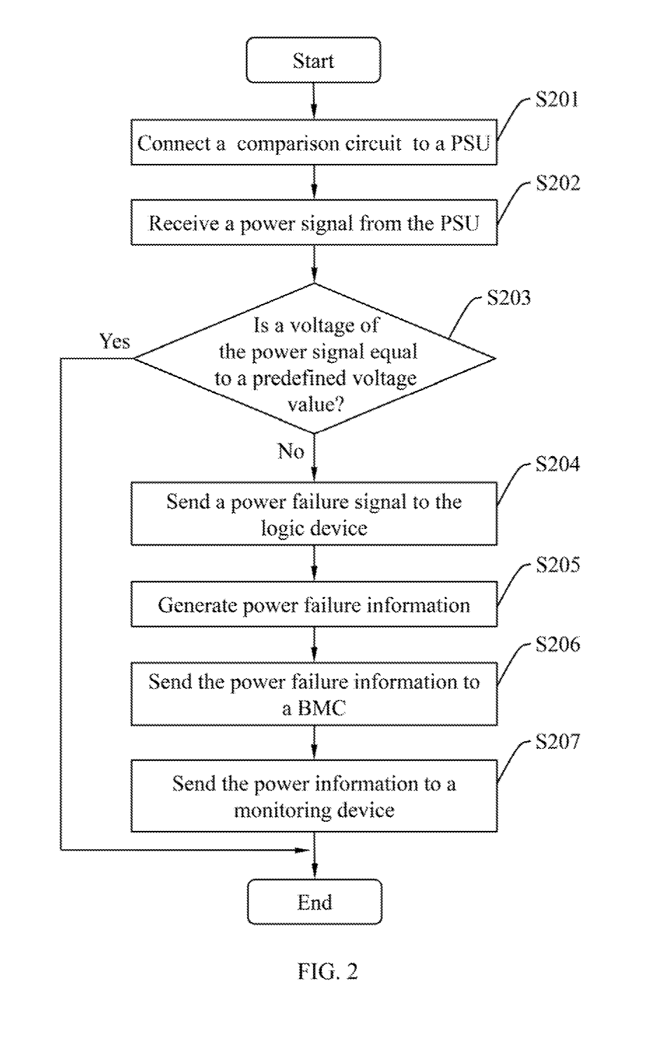

FIG. 2 shows a flowchart of one embodiment of a human-computer interaction method. The method includes the following steps.

In step S201, the comparison circuit 14 is connected to the PSU 20.

In step S202, the comparison circuit 14 receives a power signal from the PSU 20.

In step S203, the comparison circuit 14 compares a voltage of the power signal from the PSU 20 with a predefined voltage value. If the voltage of the power signal is equal to the predefined voltage value, the flow proceeds to step S204. Otherwise, the flow ends.

In step S204, the comparison circuit 14 sends a power failure signal to the logic device 12.

In step S205, the logic device 12 generates power failure information based on the power failure signal. In one embodiment, the logic device 12 collects state information of the PSU 20 and adds the state information of the PSU 20 into the power failure information. The logic device 12 detects whether the PSU 20 generates a power good signal. When the PSU 20 does not generate the power good signal, the logic device 12 determines that the PSU 20 is powering on and in a powering-on state. When the PSU 20 generates the power good signal, the logic device 12 determines that the PSU 20 has been powered on and is in a powered-on state.

In step S206, the logic device 12 sends the power failure information to the BMC 16.

In step S207, the BMC 16 sends the power failure information to the monitoring device 18 via the IP network. The monitoring device 18 generates an alarm to inform of the power failure information in response to receiving the power failure information from the BMC 16.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

What is claimed is:

1. A power failure detection apparatus, comprising:
a comparison circuit configured to receive a power signal from a power supply unit (PSU) and compare a voltage of the power signal with a predefined voltage value; and
a logic device connected to the comparison circuit;
wherein when the voltage of the power signal is not equal to the predefined voltage value, the comparison circuit is configured to send a power failure signal to the logic device, and the logic device is configured to generate power failure information based on the power failure signal.

2. The power failure detection apparatus of claim 1, further comprising a baseboard management controller (BMC) connected to the logic device, wherein the logic device is further configured to send the power failure information to the BMC.

3. The power failure detection apparatus of claim 2, wherein the logic device is further configured to collect state information of the PSU and add the state information of the PSU into the power failure information.

4. The power failure detection apparatus of claim 3, wherein the logic device is further configured to detect whether the PSU generates a power good signal, when the PSU does not generate the power good signal, the logic device is further configured to determine that the PSU is in a powering-on state, when the PSU generates the power good signal, the logic device is further configured to determine that the PSU is in a powered-on state.

5. The power failure detection apparatus of claim 4, further comprising a monitoring device in communication with the BMC via an Internet protocol (IP) network, wherein the BMC is configured to send the power failure information to the monitoring device via the IP network.

6. The power failure detection apparatus of claim 5, wherein the monitoring device is configured to generate an alarm to inform of the power failure information.

7. The power failure detection apparatus of claim 6, wherein the monitoring device comprises a display configured to display the power failure information.

8. The power failure detection apparatus of claim 6, wherein the logic device is a complex programmable logic device (CPLD) or a field programmable gate array (FPGA).

9. The power failure detection apparatus of claim 6, wherein the comparison circuit is an operational amplifier.

10. A power failure detection method, comprising:
connecting a comparison circuit to a power supply unit (PSU);
receiving a power signal from the PSU by the comparison circuit;
comparing a voltage of the power signal with a predefined voltage value by the comparison circuit;
sending a power failure signal to a logic device by the comparison circuit when the voltage of the power signal is not equal to the predefined voltage value; and
generating power failure information based on the power failure signal by the logic device.

11. The power failure detection method of claim 10, further comprising:
connecting a baseboard management controller (BMC) to the logic device; and
sending the power failure information to the BMC by the logic device.

12. The power failure detection method of claim 11, further comprising:
collecting state information of the PSU by the logic device; and
adding the state information of the PSU into the power failure information by the logic device.

13. The power failure detection method of claim 12, wherein the block of collecting state information comprises:
detecting whether the PSU generates a power good signal;
when the PSU does not generate the power good signal, determining that the PSU is in a powering-on state; and
when the PSU generates the power good signal, determining that the PSU is in a powered-on state.

14. The power failure detection method of claim 13, further comprising:
connecting a monitoring device to the BMC via an Internet protocol (IP) network; and
sending the power failure information to the monitoring device via the IP network by the BMC.

15. The power failure detection method of claim 14, further comprising generating an alarm to inform of the power failure information by the monitoring device.

16. The power failure detection method of claim 15, further comprising displaying the power failure information in a display of the monitoring device.

17. The power failure detection method of claim 15, wherein the logic device is a complex programmable logic device (CPLD) or a field programmable gate array (FPGA).

18. The power failure detection method of claim 15, wherein the comparison circuit is an operational amplifier.
